(19) United States
(12) Patent Application Publication
(10) Pub. No.: US 2009/0231301 A1
(43) Pub. Date: Sep. 17, 2009

(54) TOUCH PANEL AND MANUFACTURING METHOD THEREOF

(75) Inventors: Sean Chang, Taoyuan Hsien (TW); Chii-How Chang, Taoyuan Hsien (TW); Yang-Lin Chen, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/145,958

(22) Filed: Jun. 25, 2008

(30) Foreign Application Priority Data
Mar. 12, 2008 (TW) 097108595

(51) Int. Cl. G06F 3/045

(52) U.S. Cl. 345/174

(57) ABSTRACT

A touch panel includes a substrate, a resistive layer, a plurality of signal terminals, a conductive circuit layer, an insulation layer and a plurality of signal lines. The substrate has a touch area and a peripheral area. The signal terminals are disposed in the peripheral area and electrically connected to the resistive layer. The conductive circuit layer is disposed in the peripheral area and electrically connected to the resistive layer. The insulation layer is disposed on the signal terminals and the conductive circuit layer. The signal lines are disposed on the insulation layer and electrically connected to signal terminals, respectively.

### CROSS REFERENCE TO RELATED APPLICATIONS

This Non-provisional application claims priority under 35 U.S.C. §119(a) on Patent Application No(s). 097108595 filed in Taiwan, Republic of China on Mar. 12, 2008, the entire contents of which are hereby incorporated by reference.

### BACKGROUND OF THE INVENTION

1. Field of Invention

The present invention relates to a touch panel and a manufacturing method thereof.

2. Related Art

Recently, the touch panel has been widely applied to many kinds of electronic products, such as the mobile communication device, digital camera, MP3 player, PDA, GPS hand-held PC or ultra mobile PC (UMPC). Since the electronic products have been minimized, it is also a critical issue to decrease the area of the touch panel.

FIG. 1 shows a conventional touch screen 1, and FIG. 2 is a sectional view showing a part of the touch screen 1. The touch panel 1 includes a substrate 11, a resistive layer 12, a conductive circuit layer 13, a plurality of signal terminals 14, a protective layer 15 and a plurality of signal lines 17. The substrate 11 has a touch area T₁ and a peripheral area P₁ disposed around the touch area T₁. The resistive layer 12 is disposed in the touch area T₁ and the peripheral area P₁ of the substrate 11. The conductive circuit layer 13 and the signal terminals 14 are disposed in the peripheral area P₁ and electrically connected to the resistive layer 12. The signal terminals 14 are located at the corners of the resistive layer 12. The protective layer 15 covers the conductive circuit layer 13 and the signal terminals 14 for protection. One end of each signal line 17 is electrically connected to corresponding one of the signal terminals 14, and the other end of each signal line 17 is electrically connected to a flat cable 18.

The operation principle of the touch panel 1 will be described hereinafter. When the conductive circuit layer 13 is charged, the entire resistive layer 12 has an electric field with the distribution of the equipotential lines. If a user presses a position of the resistive layer 12, the electric field of the resistive layer 12 changes and the signal terminals 14 located at the four corners will generate signals according to the variations. Then, the generated signals are transmitted to the backend through the signal lines 17 and the flat cable 18, so that the pressed position can be obtained after the further process of the backend.

As mentioned above, the signal lines 17, which are used for signal transmission, must be isolated with the conductive circuit layer 13 and the resistive layer 12. The conventional methods for isolating the signal lines 17 will be described herein below. In the first method, the signal lines 17 are formed out of the scope of the resistive layer 12 such that it will increase the size of the entire touch panel 1. The second method is to separate the signal lines 17 from the conductive circuit layer 13 and the resistive layer 12 by laser cutting such that it will complicate the manufacturing processes and require the additional cost of the cutting apparatus.

### SUMMARY OF THE INVENTION

In view of the foregoing, it is an object of the present invention to provide a touch panel and manufacturing method thereof that can reduce the size thereof without additional process and apparatus so as to achieve the goals of minimization and low cost.

To achieve the above, the present invention discloses a touch panel includes a substrate, a resistive layer, a plurality of signal terminals, a conductive circuit layer, an insulation layer and a plurality of signal lines. The substrate has a touch area and a peripheral area. The signal terminals are disposed in the peripheral area and electrically connected to the resistive layer. The conductive circuit layer is disposed in the peripheral area and electrically connected to the resistive layer. The insulation layer is disposed on the signal terminals and the conductive circuit layer. The signal lines are disposed on the insulation layer and connected to the signal terminals, respectively.

In addition, the present invention further discloses a manufacturing method of a touch panel. The manufacturing method includes the following steps of: forming a resistive layer on a substrate, which has a touch area and a peripheral area; forming a conductive circuit layer in the peripheral area to be electrically connected to the resistive layer; forming a plurality of signal terminals in the peripheral area to be electrically connected to the resistive layer; forming an insulation layer on the conductive circuit layer and the signal terminals; and forming a plurality of signal lines on the insulation layer to be electrically connected to the signal terminals, respectively.

As mentioned above, in the touch panel and manufacturing method thereof of the present invention, the insulation layer is formed on the signal terminals and the conductive circuit layer, and then the signal lines are formed on the insulation layer. Thus, signal lines can be insulated from the conductive circuit layer and the resistive layer through the insulation layer. In addition, the elements of the touch panel are stacked vertically, so that the size of the tough panel can be reduced so as to achieve the goal of minimization. Moreover, the conventional cutting process as well as the cutting apparatus is not needed in the present invention, so the manufacturing cost can be decreased.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a conventional touch panel;

FIG. 2 is a sectional view showing a part of the conventional touch panel;

FIGS. 3A to 3C are schematic illustrations showing various aspects of a touch panel according to a first embodiment of the present invention;

FIGS. 4A to 4B are schematic illustrations showing various aspects of a touch panel according to a second embodiment of the present invention; and

FIGS. 5A to 5B are schematic illustrations showing various aspects of a touch panel according to a third embodiment of the present invention.

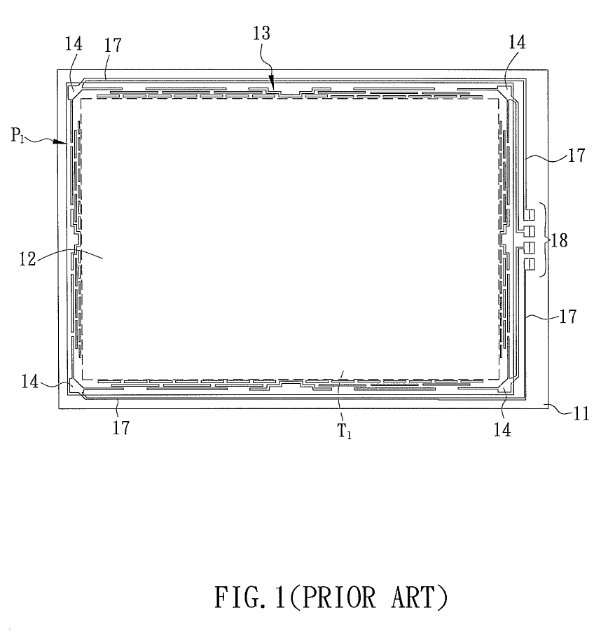

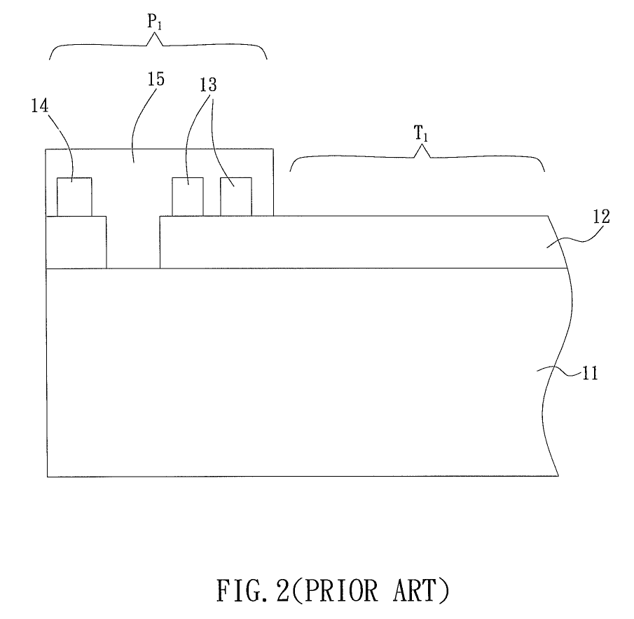

### DETAILED DESCRIPTION OF THE INVENTION

The present invention will be apparent from the following detailed description, which proceeds with reference to the accompanying drawings, wherein the same references relate to the same elements.

### First Embodiment

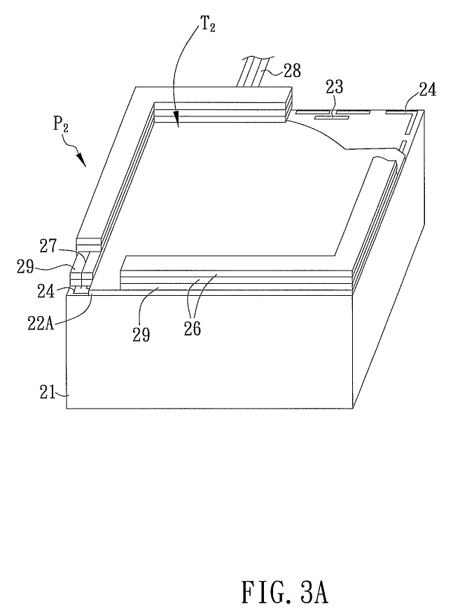

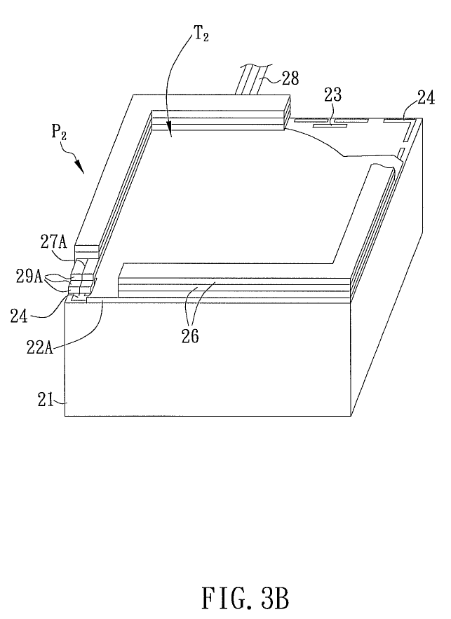

FIG. 3A shows a touch panel 2 according to a first embodiment of the present invention. The touch panel 2 includes a substrate 21, a resistive layer 22, a conductive circuit layer 23, a plurality of signal terminals 24, an insulation layer 29 and a plurality of signal lines 27.

The substrate 21 has a touch area T₂ and a peripheral area P₂ disposed around the touch area T₂. In the embodiment, the substrate 21 can be, for example but not limited to, a glass substrate or a plastic substrate. The resistive layer 22 is formed to cover the touch area T₂ and the peripheral area P₂ of the substrate 21. The material of the resistive layer 22 can be conductive metal oxide, such as indium tin oxide (ITO), indium zinc oxide (IZO), aluminum-doped zinc oxide (AZO), zinc gallium oxide (GZO) or zinc oxide (ZnO).

The conductive circuit layer 23 and the signal terminals 24 are formed in the peripheral area P₂ and electrically connected to the resistive layer 22. The conductive circuit layer 23 includes discontinuous electrodes. The signal terminals 24 are corner electrodes for applying voltage to and receiving current from the touch panel 2. The conductive circuit layer 23 and the signal terminals 24 are formed at the same time. In the embodiment, the resistive layer 22 covers the conductive circuit layer 23 and the signal terminals 24. The conductive circuit layer 23 and the signal terminals 24 can be formed on the substrate 21 by coating, printing, adhering or deposition. The material of the conductive circuit layer 23 and the signal terminals 24 can be, for example, copper or silver glue.

The insulation layer 29 is formed on the signal terminals 24 and the conductive circuit layer 23 in the peripheral area P₂, and is disposed on the resistive layer 22. The signal lines 27 are formed on the insulation layer 29 by screen printing, and electrically connected to the signal terminals 24, respectively. In the embodiment, the signal terminals 24 are exposed out of the insulation layer 29, so that the signal lines 27 can be electrically connected to the signal terminals 24.

In addition, the touch panel 2 further includes a protective layer 26 and a flat cable 28. The protective layer 26 is disposed on the signal lines 27 and the insulation layer 29. In the embodiment, the protective layer 26 can be a composite layer and is made of, for example, epoxy or silicon. The protective layer 29 can protect the conductive circuit layer 23 and the signal terminals 24. The signal lines 27 are electrically connected to the flat cable 28 for transmitting signals to a backend for further signal processing.

FIG. 3B shows another variation of the touch panel according to the first embodiment. As shown in FIG. 3B, an insulation layer 29A of the touch panel 2A has a stepped shape, so that the signal lines 27 can be electrically connected to the signal terminals 24, respectively.

FIG. 3C shows further another variation of the touch panel according to the first embodiment. As shown in FIG. 3C, the signal lines 27B pass through vias H of the insulation layer 29B so as to electrically be connected to the signal terminals 24, respectively. Herein, the vias H can be formed by etching.

### Second Embodiment

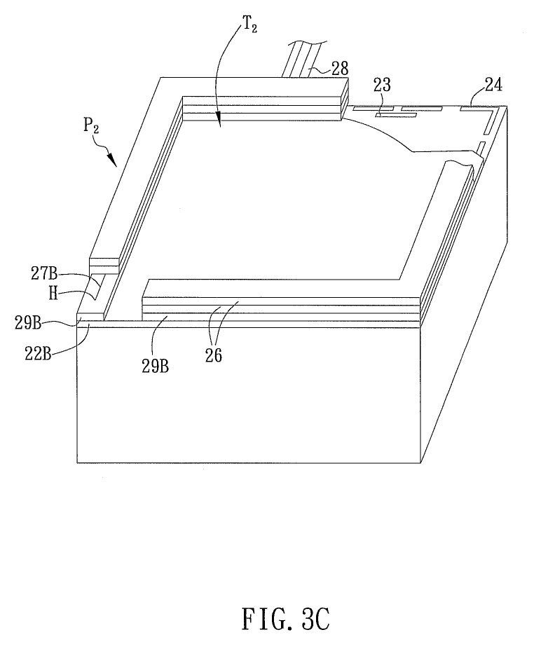

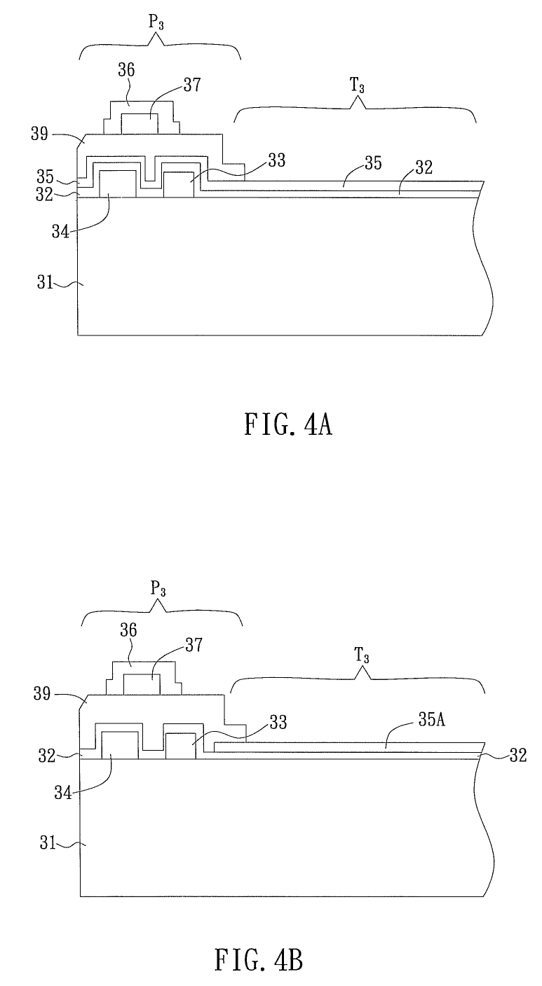

With reference to FIG. 4A, a touch panel 3 according to a second embodiment of the present invention includes a substrate 31, a resistive layer 32, a conductive circuit layer 33, a plurality of signal terminals 34, a dielectric layer 35, an insulation layer 39, a plurality of signal lines 37 and a protective layer 36. FIG. 4A shows only one signal terminal 34 and one signal line 37. To be noted, the dielectric layer 35 is formed on the resistive layer 32. In the embodiment, the dielectric layer 35 can include at least one hardening layer and/or at least one anti-reflective layer. For example, the hardening layer is formed first, and then the anti-reflective layer is formed so as to finish the formation of the dielectric layer 35. Alternatively, the anti-reflective layer is formed first, and then the hardening layer is formed thereon so as to finish the formation of the dielectric layer 35. Herein, a material of the anti-reflective layer includes silicon oxide (SiO), silicon nitride (SiN) or silicon nitrogen oxide (SiON). The connection between the signal lines 37 and the signal terminals 34 is similar to that of the signal lines 27 and the signal terminals 24 described in the first embodiment.

FIG. 4B shows another variation of the touch panel according to the second embodiment. As shown in FIG. 4B, a dielectric layer 35A of the touch panel 3A is mostly disposed on the touch area T₃ of the resistive layer 32.

### Third Embodiment

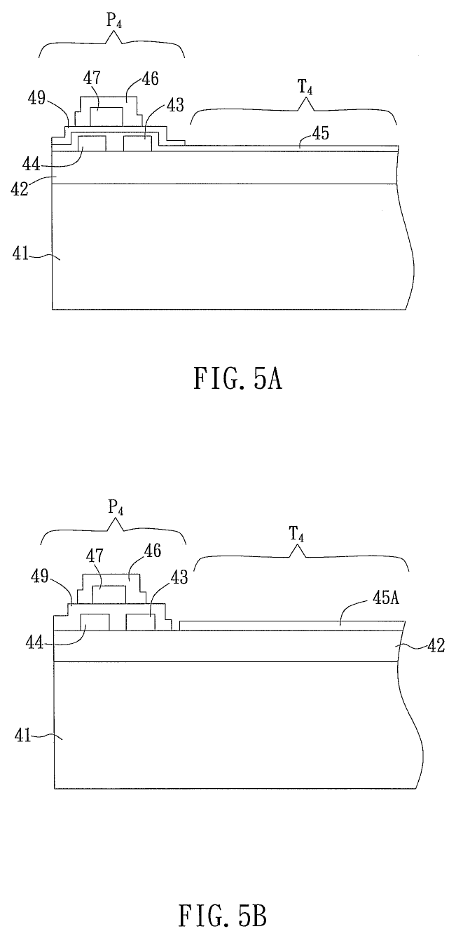

With reference to FIG. 5A, a touch panel 4 according to a third embodiment of the present invention includes a substrate 41, a resistive layer 42, a conductive circuit layer 43, a plurality of signal terminals 44, a dielectric layer 45, an insulation layer 49, a plurality of signal lines 47 and a protective layer 46. FIG. 5A shows only one signal terminal 44 and one signal line 47. In this embodiment, the resistive layer 42 is formed on the substrate 41. The conductive circuit layer 43 and the signal terminals 44 are formed on the resistive layer 42. The dielectric layer 45 is formed on the conductive circuit layer 43, the signal terminals 44 and the exposed resistive layer 42. The insulation layer 49 is formed on the dielectric layer 45 in the periphery area P₄. The signal lines 47 are formed on the insulation layer 49. The protective layer 46 covers the signal lines 47. The connection between the signal lines 47 and the signal terminals 44 is similar to that of the signal lines 27 and the signal terminals 24 described in the first embodiment.

FIG. 5B shows another variation of the touch panel according to the third embodiment. As shown in FIG. 5B, a dielectric layer 45A of the touch panel 4A is mostly disposed on the touch area T₄ of the resistive layer 42.

In summary, in the touch panel and manufacturing method thereof of the present invention, the insulation layer is formed on the signal terminals and the conductive circuit layer, and then the signal lines are formed on the insulation layer. Thus, signal lines can be insulated with the conductive circuit layer and the resistive layer through the insulation layer. In addition, the elements of the touch panel are stacked vertically, so that the size of the tough panel can be reduced so as to achieve minimization. Moreover, the conventional cutting process as well as the cutting apparatus is not needed in the present invention, so the manufacturing cost can be decreased.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A touch panel comprising:
a substrate having a touch area and a peripheral area;
a resistive layer disposed in the touch area and the peripheral area;
a conductive circuit layer disposed in the peripheral area and electrically connected to the resistive layer;
a plurality of signal terminals disposed in the peripheral area and electrically connected to the resistive layer;
an insulation layer disposed on the signal terminals and the conductive circuit layer; and
a plurality of signal lines disposed on the insulation layer, wherein the signal lines are connected to the signal terminals, respectively.

2. The touch panel according to claim 1, wherein the substrate is a glass substrate or a plastic substrate, and a material of the resistive layer comprises indium tin oxide (ITO), indium zinc oxide (IZO), aluminum-doped zinc oxide (AZO), zinc gallium oxide (GZO), zinc oxide (ZnO) or conductive metal oxide.

3. The touch panel according to claim 1, wherein a material of the signal terminals and the conductive circuit layer comprises silver glue or copper, the conductive circuit layer comprises discontinuous electrodes, the signal terminals are corner electrodes, and the conductive circuit layer and the signal terminals are formed at the same time.

4. The touch panel according to claim 1, wherein the signal line passes through a via of the insulation layer and is then electrically connected to the signal terminal, and the via is formed by etching.

5. The touch panel according to claim 4, wherein the signal terminal is exposed out of the insulation layer, and the insulation layer has a stepped shape so that the signal lines are electrically connected to the signal terminals, respectively.

6. The touch panel according to claim 5, wherein the signal lines are formed on the insulation layer by screen printing so as to be electrically connected to the signal terminals, respectively.

7. The touch panel according to claim 1, wherein the resistive layer covers the signal terminals and the conductive circuit layer, or the signal terminals and the conductive circuit layer are disposed on the resistive layer.

8. The touch panel according to claim 7, further comprising a dielectric layer disposed on the resistive layer, on the resistive layer in the touch area, or on the signal terminals, the conductive circuit layer and the exposed resistive layer.

9. The touch panel according to claim 8, wherein the dielectric layer comprises at least one hardening layer and/or at least one anti-reflective layer, and a material of the anti-reflective layer comprises silicon oxide, silicon nitride or silicon nitrogen oxide.

10. The touch panel according to claim 1, further comprising a protective layer disposed on the signal terminals and the conductive circuit layer or on the signal lines, wherein a material of the protective layer comprises epoxy or silicon.

11. The touch panel according to claim 1, wherein the signal lines are electrically connected to a flat cable.

12. A manufacturing method of a touch panel, comprising steps of:
forming a resistive layer on a substrate, wherein the substrate has a touch area and a peripheral area;
forming a conductive circuit layer in the peripheral area to be electrically connected to the resistive layer;
forming a plurality of signal terminals in the peripheral area to be electrically connected to the resistive layer;
forming an insulation layer on the conductive circuit layer and the signal terminals; and
forming a plurality of signal lines on the insulation layer to electrically connect to the signal terminals, respectively.

13. The method according to claim 12, wherein the signal terminals and the conductive circuit layer are formed in the peripheral area of the substrate by coating, printing, adhering or deposition.

14. The method according to claim 12, wherein the conductive circuit layer comprises discontinuous electrodes, the signal terminals are corner electrodes, and the conductive circuit layer and the signal terminals are simultaneously formed.

15. The method according to claim 12, wherein the signal terminal is exposed out of the insulation layer, and the insulation layer has a stepped shape so that the signal lines are electrically connected to the signal terminals, respectively.

16. The method according to claim 15, wherein the signal lines are formed by screen printing so as to electrically connect to the signal terminals, respectively.

17. The method according to claim 12, wherein the signal terminals and the conductive circuit layer are disposed on the resistive layer, or the resistive layer covers the signal terminals and the conductive circuit layer.

18. The method according to claim 17, further comprising a step of:
forming a dielectric layer on the signal terminals, the conductive circuit layer and the exposed resistive layer on the resistive layer, or on the resistive layer in the touch area.

19. The method according to claim 18, wherein the dielectric layer comprises at least one hardening layer and/or at least one anti-reflective layer, and a material of the anti-reflective layer comprises silicon oxide, silicon nitride or silicon nitrogen oxide.

20. The method according to claim 15, further comprising a step of:
forming a protective layer on the signal terminals, wherein a material of the protective layer comprises epoxy or silicon.
